(19) United States
(12) Patent Application Publication
(10) Pub. No.: US 2010/0304041 A1
(43) Pub. Date: Dec. 2, 2010

(54) Method For Coating Honeycomb Bodies

(76) Inventors: Tonia Havewala Fletcher, Big Flats, NY (US); Karen Knapp, Addison, NY (US); Gabrielle Lange, Corning, NY (US); William Paul Ryszytiwskyj, Corning, NY (US); Rebecca Lynn Schulz, Horesheads, NY (US); Gary Graham Squier, Elmira, NY (US)

Correspondence Address: CORNING INCORPORATED, SP-TI-3-1, CORNING, NY, 14831, US

(21) Appl. No.: 12/474,889

(22) Filed: May 29, 2009

(51) Int. Cl. B29C 71/02; B05D 3/02; B05D 3/12

(52) U.S. Cl. 427/542; 427/372.2; 427/541; 427/346

(57) ABSTRACT

A ceramic coating is provided on the outer surface of a honeycomb body by applying a first layer of coating material comprising a ceramic or ceramic-forming component to the outer surface, subjecting at least part of the first layer to at least partial curing, and then adding one or more additional layers of coating material comprising a ceramic or ceramic-forming component over the previously applied and cured layer(s).

### BACKGROUND

External ceramic coatings or “skins” are frequently applied to the outer surfaces of large ceramic honeycomb bodies to provide smooth covering surfaces imparting high strength and good dimensional control. Skin application is generally carried out after the piece has been machined to provide a honeycomb matrix conforming to specified diameter requirements, most often after the matrix has been fired to develop its final crystalline structure and strength. Curing of the applied skin is accomplished through an additional manufacturing step such as drying, or through a re-firing of the coated piece to sinter or reaction-sinter the skin material.

### SUMMARY

The present disclosure sets forth methods for providing improved honeycomb bodies incorporating applied skin coatings of high strength that are resistant to damage during production and in use, and that are largely free of skin cracks resulting from the drying and/or firing steps of manufacture. These properties are secured through a multi-layer approach to skin application.

Among the various embodiments of the methods disclosed herein are methods for applying a ceramic coating to an outer surface of a honeycomb body such as a honeycomb matrix that comprise the steps of (i) applying a first layer of coating material comprising a ceramic or ceramic-forming component to the outer surface of the body and (ii) applying at least one additional layer of coating material comprising a ceramic or ceramic-forming component on top of the first layer, but wherein (iii) at least part of the first layer is subjected to at least partial curing prior to applying the at least one additional layer.

In general, curing in accordance with the disclosed methods comprises heating the first layer or a portion thereof, for example by exposing at least part of the first layer to infrared radiation, microwave radiation, convective heating, or a combination thereof In particular embodiments, curing comprises drying at least a part of the first layer to remove a liquid component, e.g., a water vehicle, from the layer. Drying may be facilitated by heating the first layer using one or a combination of the above heating methods.

In some embodiments, methods for applying multi-layer coatings to honeycomb bodies according to the present disclosure are facilitated by rotating the bodies during coating application. The honeycomb bodies comprise opposing first and second end faces and an outer side surface extending between the first and second end faces, and the bodies are disposed about a longitudinal axis extending through the first and second end faces. A coating material is sprayed onto the outer side surfaces of the bodies, while rotating the bodies about the longitudinal axis, to form a first wet layer of the coating material. The bodies may be rotated 360° or more about the longitudinal axis for the purpose of applying this layer or succeeding layers. The first wet layer is then at least partially dried prior to forming a succeeding wet layer. In further particular embodiments of these methods the bodies are also rotated about the longitudinal axis while at least partially drying the first wet layer.

The steps of spraying and drying layers of coating material can be arranged in various ways. In some embodiments the step of spraying the coating material is terminated prior to the step of drying or partially drying the first wet layer. In other embodiments, the steps of spraying the coating material and drying the resulting wet layer are carried out concurrently. Particular examples of the later embodiments comprise the steps of rotating the body about the longitudinal axis and applying one part of a first layer of coating material to a first part of the outer surface corresponding to a first arc of rotation, and then heating the first layer on the first part of the outer surface while simultaneously applying another part of the first layer of coating material to a second part of the outer surface corresponding to a second arc of rotation.

### BRIEF DESCRIPTION OF THE DRAWINGS

The methods disclosed herein are further described below with reference to the appended drawings, wherein:

FIG. 1 is a schematic perspective illustration of a coated honeycomb body produced in accordance with the description;

FIG. 2 is a schematic side elevational view of apparatus for the production of a coating honeycomb body; and

FIGS. 3a and 3b consist of schematic illustrations of the application of a multi-layer coating to a honeycomb body.

### DETAILED DESCRIPTION

A conventional method for applying a skin layer to a honeycomb body or matrix is the so-called “doctor blade” method. According to that method the solid and liquid raw materials for the coating mixtures are proportioned to produce a plastic cement which is applied and smoothed with a plate or blade. The honeycomb body may be a dried shape composed of a ceramic-forming component, or it may be a fired shape wherein a ceramic-forming component or components have been converted to a strong monolithic ceramic material. The honeycomb body is typically rotated during cement application to shape a smooth layer of a suitable thickness. The thus-applied cement coating is then dried to remove unbound water, suitably by heating to a moderately elevated temperature for several hours, e.g., for 4 hours at 65° C. In some cases the body and coating are fired to convert the coating, or coating and body, to a monolithic ceramic body or coating.

There are several drawbacks associated with such coating application and drying processes. Among the more commonly encountered problems are poor adherence of the coating mixture to the honeycomb matrix during application and skin crack formation during drying or firing. Further problems include uneven skin thickness, cement waste during application, and weakness in the dried coating leading to skin flaking or chipping during post-application handing or in use.

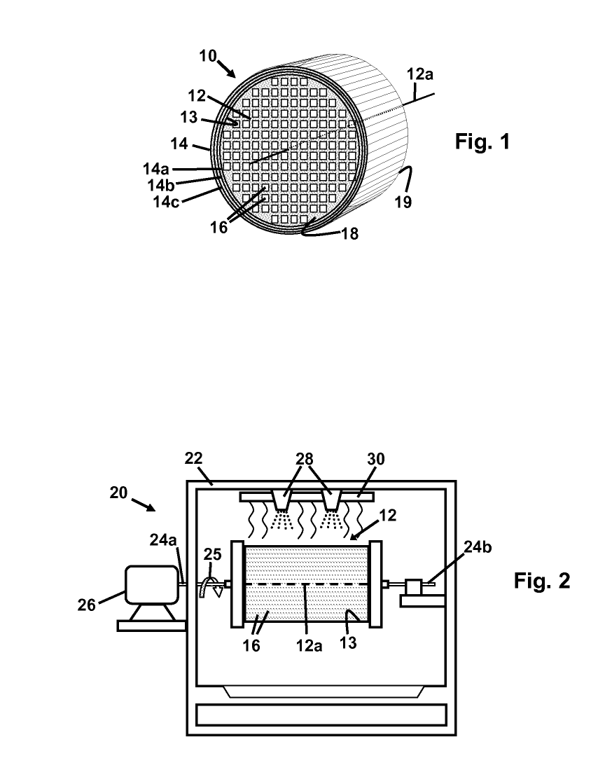

The honeycomb body coatings or skins disclosed in the present application are particularly useful for application to green (unfired) honeycomb matrices, although application to fired honeycomb bodies is advantageous as well. The skins are applied to the green matrices in multiple thin layers or veneers using sheet, paste or slurry preparations formed from a raw material mixture that can be converted to a sintered ceramic skin at matrix firing temperatures. Firing thus converts the green matrix to a strong ceramic matrix and the paste or slurry coating to a crack-free, chip-resistant ceramic skin surrounding the side periphery of the matrix in a single firing step. FIG. 1 of the drawings presents a schematic illustration, not in true proportion or to scale, of a coated honeycomb substrate 10 comprising a cylindrical honeycomb matrix 12 having an outer surface 13 to which a ceramic skin 14 comprising thin veneers or layers 14a, 14b, 14c have been applied. Honeycomb channels such as channels 16 of substrate 10 are aligned in parallel with center axis 12a of matrix 12.

The proportions of the ceramic raw materials incorporated in the film, paste or slurry used to provide honeycomb skins according to the disclosed methods are selected to insure compatibility with different filter matrix materials. Additional constituents are chosen to secure strength and adhesion of the applied coatings and/or to adjust the thermal expansion of the fired coatings to match that of the matrix. In the case of a dried green honeycomb matrix formed of clay, talc and alumina in proportions convertible to cordierite ceramic upon firing, for example, the coating composition can comprise a mixture of talc, clay, silica and alumina combined with organic binders such as methylcellulose and/or polyethylene oxide binder and vehicle constituents such as water. The resulting mixture is applied as a coating to the side surfaces of the unfired matrix and co-fired with the matrix to approximately 1400° C. to convert both the matrix and the coating to cordierite.

For the purpose of reducing skin cracks and other defects in the coatings or skins to be applied in accordance with the disclosed methods, the skins are formed of thin layers or veneers. Embodiments of those methods include those wherein each thin layer or veneer that is applied for curing has a thickness of less than 2.5 mm, for example layers having a thickness greater than or equal to 0.1 mm and less than or equal to 1 mm. Embodiments wherein the coating material is a slurry or a paste of a ceramic or ceramic-forming component are useful, as are those wherein a foamable mixture, or even a tape-cast sheet, of a ceramic or ceramic-forming component, provide improved results.

While any of the above-described coating materials have utility for the fabrication of improved honeycomb products in accordance with the present disclosure, methods wherein the coating material is a slurry, and wherein at least one of the layers of that material is applied by cascading or spraying the slurry onto the honeycomb body can be particularly well-suited for economic production. Included are embodiments of those methods wherein the honeycomb is rotated about an axis while at least one of the layers of coating material is applied. Also included are embodiments wherein the honeycomb body is rotated about an axis while at least one of the layers of coating material is subjected to curing, for example curing by heating for the purpose of drying or bonding to the body. Thus the following descriptions refer particularly to such embodiments even though the methods disclosed herein are not intended to be limited thereto.

As noted above, the methods of the present disclosure generally involve skin formation through the application of multiple thin layers or veneers of the coating formulation to the honeycomb matrix. For that reason, although various methods for applying the veneer layers can be employed depending upon the composition, viscosity and/or plasticity of the material selected to form the layers, the spraying or cascading of slurried coating formulations onto the matrix can conveniently provide desirably thin veneers. Suitable veneer layer thicknesses attainable through spraying and/or cascading are in the range of 0.1-1 mm although thicker layers, e.g., up to 2.5 mm can be provided if needed.

As noted above, alternative coating methods include the application to the outer matrix surface of thin plasticized sheets formed of tape-cast coating material, or sprayed layers of foamed coating formulations. In the case of plastic tape application, in particular, preheating or pre-wetting of the matrix prior to applying the tape can improve layer adherence to the surfaces of the honeycomb matrix.

In those embodiments of the disclosed methods involving the spraying of matrix surfaces with multiple thin coating layers, the applied layer or layers are generally partially or completely dried prior to the application of a further layer or layers. Suitable drying methods include one or a combination of: infrared heating, microwave heating, and flowing hot air. The advantages of the disclosed methods can include (i) reductions in drying cracks, (ii) reductions in other coating defects such as skin chips, (iii) improvements in skin material utilization, (v) improved adhesion between skin and matrix, and/or (vi) improved product appearance.

Drying each layer prior to application of additional layers is particularly effective to prevent cracking of the layered coating during drying or firing. Drying of thin paste or slurry layers is suitably accomplished, for example, by hot air gun, infrared radiation, and/or radio-frequency or microwave heating. Infrared radiation drying is a particularly effective means for rapidly drying thin sprayed layers.

Apparatus suitable for applying veneer layers to a honeycomb matrix by spraying is schematically illustrated in FIG. 2 of the drawings. As shown in FIG. 2, apparatus 20 includes a support frame 22 for supporting horizontally opposed spindles 24a and 24b, those spindles being arranged to contact and support a cylindrical honeycomb matrix 12 for rotation in the apparatus. When positioned in apparatus 20, matrix 12 is oriented as shown with honeycomb channels 16 and center axis 12a of the matrix in horizontal alignment with the spindles so that spindle 24a can rotate matrix 12 about axis 12a, for example in the direction of arrow 25, when electric motor 26 is activated.

Also supported by frame 22 are one or more spray heads 28, these being arranged to direct a uniform deposit of a slurried coating formulation to the side surface of matrix 12 as the matrix is rotated about its axis 12a. Finally, frame 22 may further support heating means such as infrared radiation source 30. The latter source is arranged to direct radiation toward the side surface of matrix 12 to dry coating material that has been deposited on that surface by spray heads 28.

In operation to deposit one of a series of thin coating layers, matrix 12 can be rotated 360° or more about axis 12a while a slurry veneer is applied to the matrix via the precision spray heads. Where the slurry provides a relatively thick layer, only one rotation may be applied before drying. Where the applied layer is the first layer to be applied to the matrix, it can be useful to spread and smooth that layer onto the matrix, for example using a sponge, brush, or doctor blade, to fill any open channels or similarly large depressions in the surface of the matrix.

As each coating is applied, or thereafter, the infrared radiation source is activated to at least partially dry the thus-formed wet coating layer prior to the application of further wet coating layers. If desired, additional rotations of the matrix for further heating and drying may be carried out during deposition, or after all of the thin layers have been deposited. Where coating application is to be carried out via a cascade application of slurry, spray heads 28 may simply be replaced by a controlled release slurry tank.

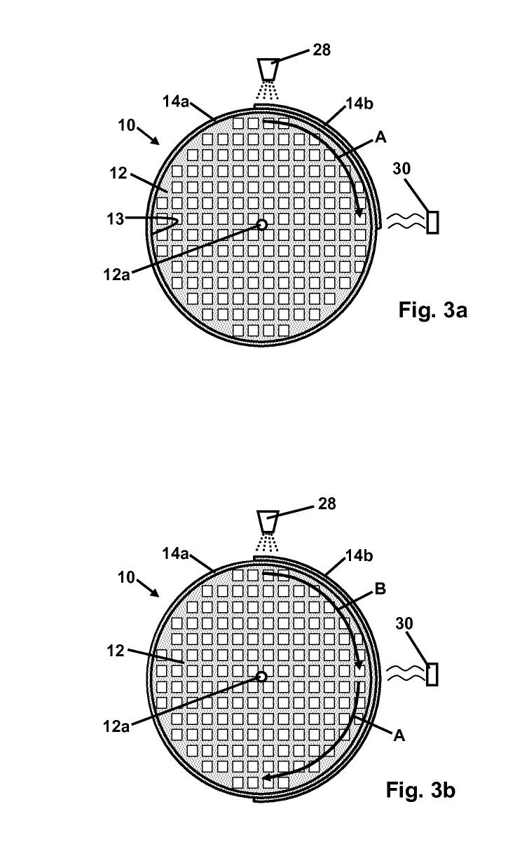

FIGS. 3a and 3b of the drawings are schematic illustrations of an exemplary process for the concurrent application and partial drying of wet coating layers applied to a honeycomb body consisting of honeycomb matrix 12 as shown in FIG. 2 of the drawings. FIG. 3a provides a schematic end view of honeycomb matrix 12 during the application of a thin coating layer 14b to a side surface 13 of the matrix (in this particular example application is over a previously applied and dried thin coating layer 14a, although the procedure may be the same for all of the layers to be applied).

To apply a thin coating layer such as layer 14b, matrix 12 is rotated through a first arc of rotation about longitudinal axis of rotation 12a in the direction of arrow A while a part of the layer 14b is deposited on a first part of outer surface 13. Deposition is in the form of coating material supplied from precision spray head 28. The magnitude of the first arc of rotation, and the resulting size of the part of outer surface 13 coated in this step, are indicated generally by the length of arrow A in FIG. 3a.

Referring next to FIG. 3b, after the first part of outer surface 13 has been coated by a first part of coating layer 14b, another part of outer surface 13 is covered with a second part of coating layer 14b. Again deposition is from precision spray head 28, and is carried out as matrix 12 is rotated about axis 12a for the length of a second arc of rotation. The magnitude of the second arc of rotation and size of the additional part of outer surface 13 that is coated in this step are indicated generally by the length of arrow B in FIG. 3b.

Simultaneously with the deposition of the second part of coating layer 14b onto the part of outer surface 13 indicated by arrow B in FIG. 3b, the first part of coating layer 14b disposed on the first part of outer surface 13 indicated by arrow A in FIG. 3b is heated. Heating is by infrared radiation source 30, and results in at least partial drying of that part of layer 14b disposed on the first part of outer surface 13. Rotation in this manner through succeeding arcs of rotation may be continued until a full coating of outer surface 13 by a sprayed and dried coating layer 14b is achieved, and optionally additional coating layer(s) similarly applied.

Methods for the concurrent coating and drying of honeycomb bodies as illustrated in FIGS. 3a and 3b of the drawings may be carried out in a number of different ways, the choice of method depending among other variables upon the formulation of the coating material as well as the efficiency of the heat source and amount of liquid phase material to be removed from the coating material. Particular embodiments of those methods include those wherein the first arc of rotation is less than 360°, e.g., is approximately 90° as in the drawings. Although not required, the first and second parts of the outer surface 13 to be coated, and thus first and second parts of the thin coating layer to be applied, are directly adjacent to each other as in FIGS. 3a and 3b. Further examples of particular embodiments of concurrent application and drying steps include those wherein the first arc of rotation is 180°, as well as those wherein the sum of the first and second arcs is 360°.

Particularly in embodiments wherein the application of coating material is to be interrupted for the purpose of drying the applied coating layer prior to the deposition of another layer, the honeycomb body will often be rotated more than 360° about the longitudinal axis during the spraying of one of the thin layers. For example, the body may be rotated at least 540° about the longitudinal axis where rotation speeds are high and/or where the sprayed slurry layers being applied are very thin.

It will be apparent from the drawings and foregoing descriptions that the spraying of coating materials onto the outer surfaces of honeycomb bodies may be carried out utilizing other than two precision spray heads, including multiple heads operating at various spray angles. The apparatus and mode of operation of the selected spraying equipment can be programmable to facilitate easy adaptation to the coating of particular bodies of various part sizes and honeycomb matrix compositions.

The methods disclosed therein are further illustrated by the following example, which is intended to be illustrative rather than limiting.

### EXAMPLE

A ceramic honeycomb product incorporating a honeycomb matrix and a smooth, substantially defect-free ceramic skin, both of cordierite composition, is fabricated in accordance with the following procedure. A honeycomb matrix of circular cylindrical shape about 30 cm in diameter and 25 cm in length having honeycomb channels aligned in parallel with the geometric axis of rotation of the cylinder is first provided. That matrix is fabricated from a dried green extruded honeycomb shape of a composition comprising clay, talc and alumina in proportions that will yield a reaction-sintered cordierite honeycomb structure upon firing.

The honeycomb shape is first subjected to surface grinding to remove excess surface material until a matrix of the above-specified diameter is produced. A coating slurry for the application of a multi-layer coating to this matrix is then provided. The coating slurry has a composition comprising a mixture of dry inorganic powders, a methyl cellulose binder, and a water vehicle. The inorganic powder mixture includes 11.7 parts hydrated kaolin clay, 40.6 parts talc, 18.6 parts hydrous alumina, 14.7 parts calcined alumina, and 14.4 parts of silica powder by weight. The slurry is prepared by thoroughly blending the inorganic powder constituents with one part methyl cellulose binder by weight, and then adding deionized water until a sprayable fluid consistency having a viscosity of about 20 Pa·s is achieved. The particle sizes of the powders are maintained below about 400 mesh, e.g., having an average particle size of about 38 μm, to improve spraying characteristics.

A spray gun employing compressed air as a propellant at an air pressure of 100 psi is then used to apply this slurry to the cylindrical outer surface of the honeycomb matrix. In general, air pressures in the range of 30-200 psi and slurry viscosities in the range of 5-30 Pa·s, are equivalently effective for this purpose.

An initial layer of the coating slurry is first applied as above described, and then the applied layer is dried by the application of infrared radiation from a 6 kW radiation source for a period of 1.5 min. This heating is effective to remove approximately 70% of the free water from the coating. The dried coating has a thickness of about 0.5 mm.

Depending upon the thickness of the applied coating, and upon other factors, IR radiation of higher or lower power, e.g., in the 3-25 kW range, can alternatively be used for the purpose of drying. Other factors affecting drying time include the size (diameter and length) of the matrix being coated, the amount of vehicle included in the coating, and the particular composition of the coating being heated.

Following this drying treatment a second coating is applied and dried utilizing the same spraying and infrared heating procedure. The resulting layered coating has an average thickness of approximately 1 mm. Deposition of two to four coating layers by this method, each about 0.5 mm in thickness, provides a dry adherent coating with few or no drying cracks.

From the foregoing descriptions and examples it will be apparent that the disclosed methods are applicable to a broad range of honeycomb body configurations and compositions, and may be readily adapted, for example, to the production of smooth, adherent and largely defect-free layered coatings or skins on any of the honeycomb products presently used for filtering or otherwise treating combustion engine exhaust gases to remove solid and/or gaseous pollutants therefrom. Adaptations involving firing of such coatings concurrently with the firing of the supporting honeycomb bodies provide highly durable coated honeycomb products while at the same time simplifying production processing and reducing overall production costs. These and other modifications and adaptations of the particular methods disclosed herein may be utilized by those of ordinary skill in the art without departing from the spirit and scope of the appended claims.

What is claimed is:

1. A method for applying a ceramic coating to an outer surface of a honeycomb body comprising
applying a first layer of coating material comprising a ceramic or ceramic-forming component to the outer surface of the body and
applying at least one additional layer of coating material comprising a ceramic or ceramic-forming component on top of the first layer;
wherein at least part of the first layer is subjected to at least partial curing prior to applying the additional layer.

2. The method of claim 1 wherein curing comprises exposing at least part of the first layer to infrared radiation, microwave radiation, convective heating, or a combination thereof

3. The method of claim 1 wherein curing comprises drying at least a part of the first layer to remove a liquid component therefrom.

4. The method of claim 3 wherein drying comprises exposing at least part of the first layer to infrared radiation, microwave radiation, convective heating, or a combination thereof

5. The method of claim 1 wherein each layer has a thickness of less than 2.5 mm.

6. The method of claim 5 wherein each layer has a thickness of greater than or equal to 0.1 mm and less than or equal to 1 mm.

7. The method of claim 1 wherein the coating material is selected from the group consisting of: a slurry of a ceramic or ceramic-forming component, a paste of a ceramic or a ceramic forming component, a foamable mixture of a ceramic or ceramic-forming component, and a tape-cast sheet comprising a ceramic or ceramic-forming component.

8. The method of claim 1 wherein the honeycomb body is comprised of a ceramic or a ceramic-forming component.

9. The method of claim 7 wherein the coating material comprises a slurry, and wherein at least one of the layers of coating material is applied by cascading or spraying the slurry onto the honeycomb body.

10. The method of claim 9 wherein the honeycomb body is rotated about an axis while at least one of the layers of coating material is applied.

11. The method of claim 9 wherein the honeycomb body is rotated about an axis while at least one of the layers of coating material is subjected to curing.

12. A method of applying a multi-layer coating to a honeycomb body comprising opposing first and second end faces and an outer side surface extending between the first and second end faces, the body being disposed about a longitudinal axis extending through the first and second end faces, the method comprising:
spraying a coating material onto the outer side surface while rotating the body about the longitudinal axis to form a first wet layer of the coating material, and
at least partially drying the first wet layer prior to forming a succeeding wet layer.

13. The method of claim 12 wherein the body is rotated about the longitudinal axis while at least partially drying the first wet layer.

14. The method of claim 13 wherein the step of spraying the coating material is terminated prior to the step of drying the first wet layer.

15. The method of claim 13 wherein the steps of spraying a coating material and drying a first wet layer are carried out concurrently.

16. The method of claim 12 wherein the body is rotated 360° or more about the longitudinal axis to form the first wet layer.

17. A method of applying a multi-layer coating to a honeycomb body comprising opposing first and second end faces and an outer side surface extending between the first and second end faces, the body being disposed about a longitudinal axis extending through the first and second end faces, the method comprising:
rotating the body about the longitudinal axis and applying one part of a first layer of coating material to a first part of the outer surface corresponding to a first arc of rotation;
heating the first layer on the first part of the outer surface while simultaneously applying another part of the first layer of coating material to a second part of the outer surface corresponding to a second arc of rotation.

18. The method of claim 17 wherein the first and second parts are directly adjacent to each other.

19. The method of claim 19 wherein the first arc is 180°.

20. The method of claim 17 wherein the sum of the first and second arcs is 360°
